(19) United States
(12) Patent Application Publication
(10) Pub. No.: US 2004/0200694 A1
(43) Pub. Date: Oct. 14, 2004

(54) Powered rotary board turner

(76) Inventors: Deane R. Henderson, Salmon Arm (CA); Geoff Wight, Salmon Arm (CA)

Correspondence Address: ANTONY C. EDWARDS, SUITE 800 - 1708 DOLPHIN AVENUE, KELOWNA, BC, V1Y 9S4, CA

(21) Appl. No.: 10/808,314

(22) Filed: Mar. 25, 2004

Related U.S. Application Data
(60) Provisional application No. 60/461,386, filed on Apr. 10, 2003.

(51) Int. Cl. B65G 47/24

(52) U.S. Cl. 198/411

(57) ABSTRACT

A method and apparatus of turning a board while the board is being transferred in a conveyance system includes a conveyance system for transporting a board, a rotary turning device for rotating the board, a bumper stop for restraining the board and a speed-up belt for increasing or decreasing delivery of the board. The rotary turning device rotates at a constant rate relative to the conveyance system speed; the bumper stop stops the flow of the lumber allowing the rotary turning device to pick up the board; the speed-up belt accelerates the board to the front of the lug space and the conveyance system transports the board while it is turned within the lug space.

### CROSS REFERENCE TO RELATED APPLICATION

This application claims priority from U.S. Provisional Patent Application No. 60/461,386 filed Mar. 25, 2003 entitled Powered Rotary Board Turner.

### FIELD OF THE INVENTION

The present invention relates generally to a board turner and more specifically it relates to a method and apparatus for the powered rotary turning of a board while the board is being conveyed.

### BACKGROUND OF THE INVENTION

Rotary board turners in the prior art do not incorporate a physical stop and are not necessarily driven. Conventional board turners do not provide for controlling the speed of the conveyor while rotating the board. Conventional board turners may also fail to turn boards in a conveyance system as the conveyance system is started and stopped.

Prior art board turners are not as suitable for controlling the speed of the conveyor and rotating the board while the board is being transferred in a conveyance system as is the board turner according to the present invention. The main problem with conventional board turners is the inability to control the speed of the conveyance system while reliably rotating the board. Another problem in the prior art is the inability to select individual boards to be turned as the conveyance system speed is changed. Another problem with existing turners is the need to change timing with various thickness, width and wane conditions of the boards.

In these respects, the powered rotary board turner according to the present invention substantially departs from the conventional concepts and designs of the prior art, and in so doing provides an apparatus primarily developed for the purpose of maintaining reliable board turning as conveyance system speed increases or decreases over a wide range of speeds and as product sizes vary.

### SUMMARY OF THE INVENTION

In view of the foregoing disadvantages inherent in the known types of board turners now present in the prior art, the present invention provides a new powered rotary board turner construction which comprises a variable speed or fixed speed conveyance system for transporting the boards, a rotary turning device for rotating a board, a bumper stop for restraining the board and a speed up belt for increasing or decreasing delivery of the board. The rotary turning device rotates at a rate relative to the lug or conveyance speed; the bumper stop stops the flow of the lumber allowing the rotary turning device to pick up the board; the speed-up belt or some other acceleration means accelerates the board to the front of the lug space or bumper and the Conveyance System transports the board.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a powered rotary board turner that will overcome the shortcomings of the prior art devices.

An object of the present invention is to provide a powered rotary board turner for a method and apparatus of turning a board while the board is being transferred in a conveyance system.

Another object is to provide a powered rotary board turner that controls the speed of the article.

Another object is to provide a powered rotary board turner that accelerates the board to the front of the conveyance system.

Another object is to provide a powered rotary board turner that stops the board by a retractable or fixed bumper stops which are proud of the top of the conveyance system.

Another object is to provide a powered rotary board turner that picks up the board and rotates it over the bumper stop and gravity feeds it to the same conveyor and lug space it originates from.

Another object is to provide a powered rotary board turner that rotates at a rate which is constant relative to the conveyance system speed, and which speeds up or down as the conveyance system speed increases or decreases.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

In summary, in the present invention a conveyor has discreet board engaging means in spaced relation therealong defining board carrying spaces therebetween for carrying boards aligned across a downstream flow direction. An acceleration means accelerates a board in a board carrying spaced to the downstream most end of the space. A rigid stop is mounted in, or is selectively translated into, a board engaging position so as to engage the board in the space when at the downstream end of the space. At least one rotator arm engages the underside of the board once engaged against the stop and rotates the board one hundred eighty degrees over the stop so as to deposit the board towards the upstream end of the board carrying space.

The conveyor may be a lugged conveyor and the discreet board engaging means may be a spaced array of lugs mounted on the conveyor. The acceleration means may be a speed-up belt, and the rigid stop may be a bumper stop.

The bumper stop may be mounted so as to extend or be extendable into the downstream flow direction to engage the board when in the board carrying space. The acceleration means may have an upstream end and an opposite downstream end, and the bumper stop may be adjacent the downstream end of the acceleration means.

The at least one driven rotator arm may include a single, or a pair of oppositely disposed, rigid arms rigidly cantilevered from a driven shaft, wherein the driven shaft is driven at a rotational speed which is constant relative to a translation speed of the conveyor. The driven shaft and the conveyor may be mechanically linked to one another by driving linkage means so as to provide the constant relative speeds between the shaft and the conveyor. The at least one driven rotator arm may be rotatably mounted on driving means mounted beneath an upper surface of the conveyor and adjacent the rigid stop.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a planar view of one embodiment of the board turner according to the present invention.

FIG. 2 is a side elevation view of the embodiment of FIG. 1.

FIG. 3 is a horizontal view from the end of the conveyance system.

FIGS. 4, 5, 6, 7, 8, 9a, 9b, 9c and 10 illustrate the process of turning a board in 3 inch travel increments wherein:

FIG. 4 is a view of a board approaching the device from upstream.

FIG. 5 is a view of the board upstream from the conveyance system and the belt thereby slipping under the board.

FIG. 6 is a view of the board resting against the bumper stop.

FIG. 7 is a view of the board at rest against bumper stop just prior to the turner engaging board.

FIG. 8 is a view of the board being raised off of the belt by the rotary board turner.

FIG. 9 (a) is a view of the board being rotated around the bumper stop before reaching the vertical.

FIG. 9 (b) is a view of the board being rotated around the bumper stop almost at the vertical.

FIG. 9 (c) is a view of the board being rotated around the bumper stop just past the vertical.

FIG. 10 is a view of the board falling from the position of FIG. 9c so as to be gravity fed away from the rotary board turner.

FIG. 11 (a) is a view of the board being initially sped away from the turner by the speed up belt.

FIG. 11 (b) is a view of the board being further sped away from the turner by the speed up belt.

FIG. 12 is a view of the board being carried away by the conveyance system.

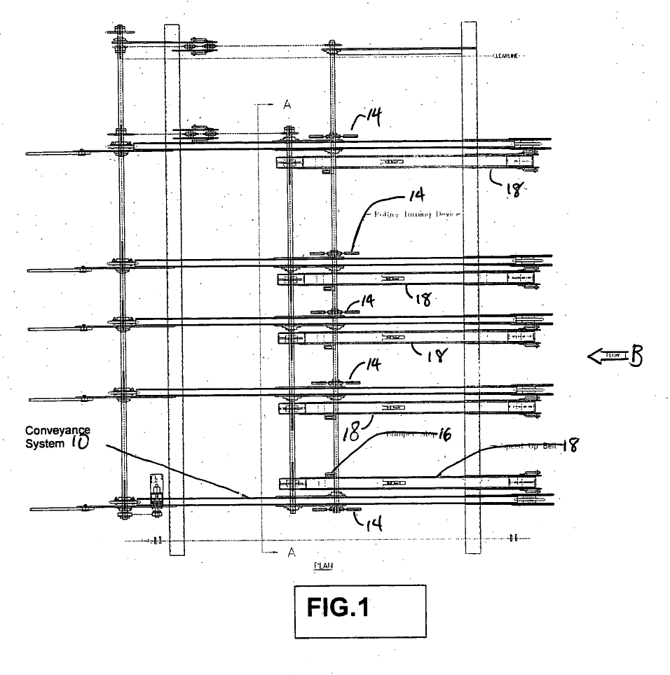

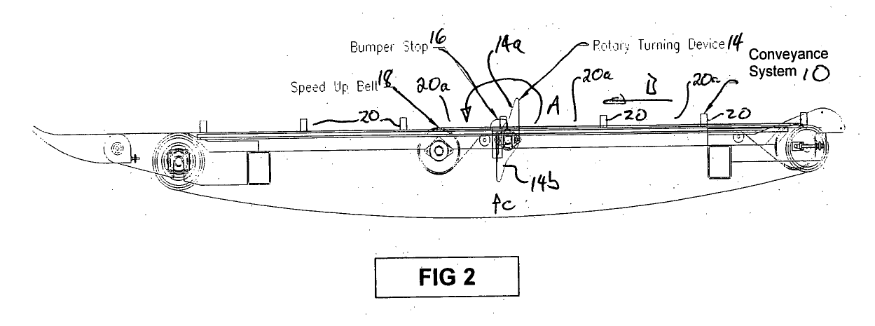

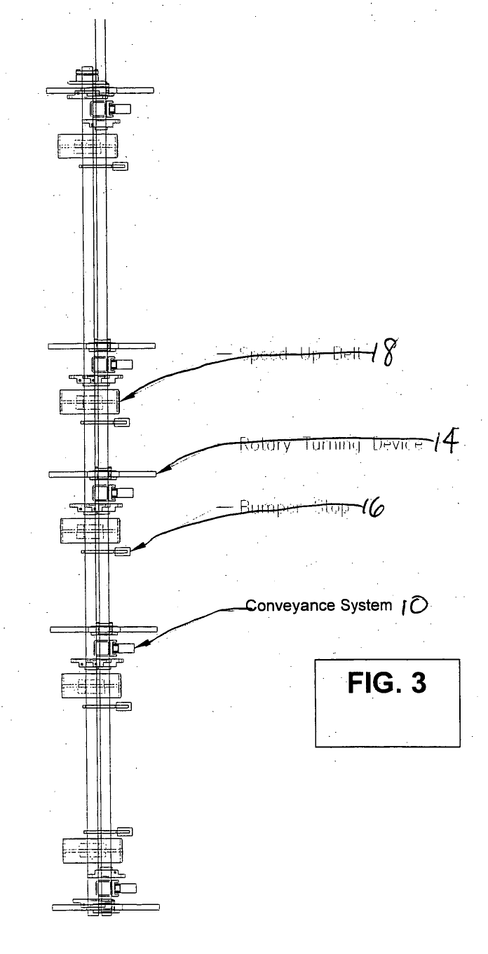

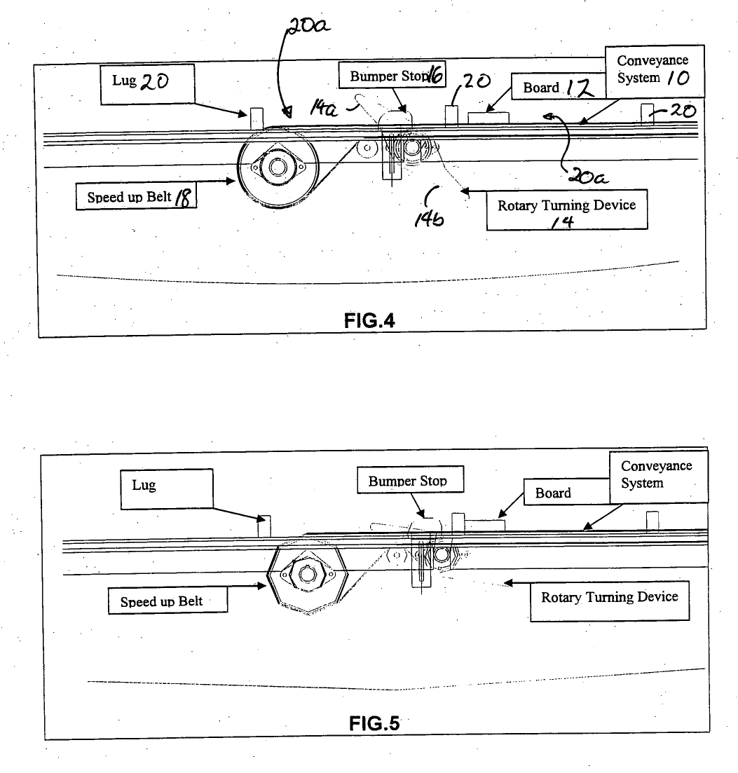

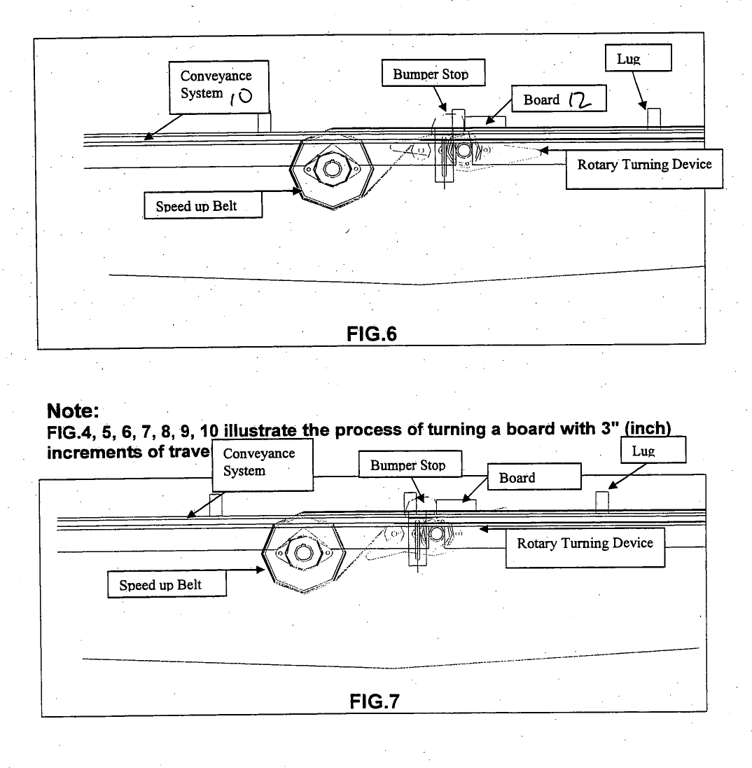

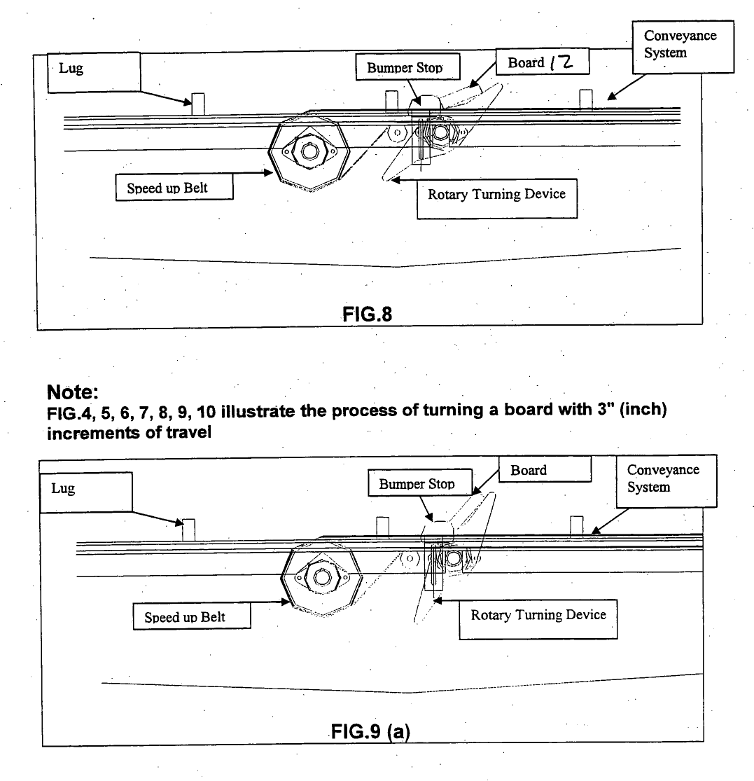

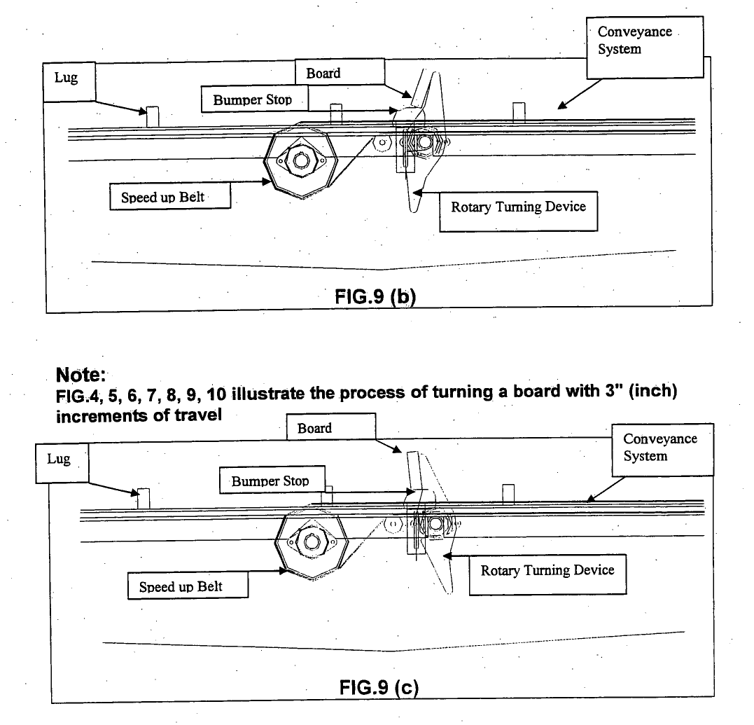

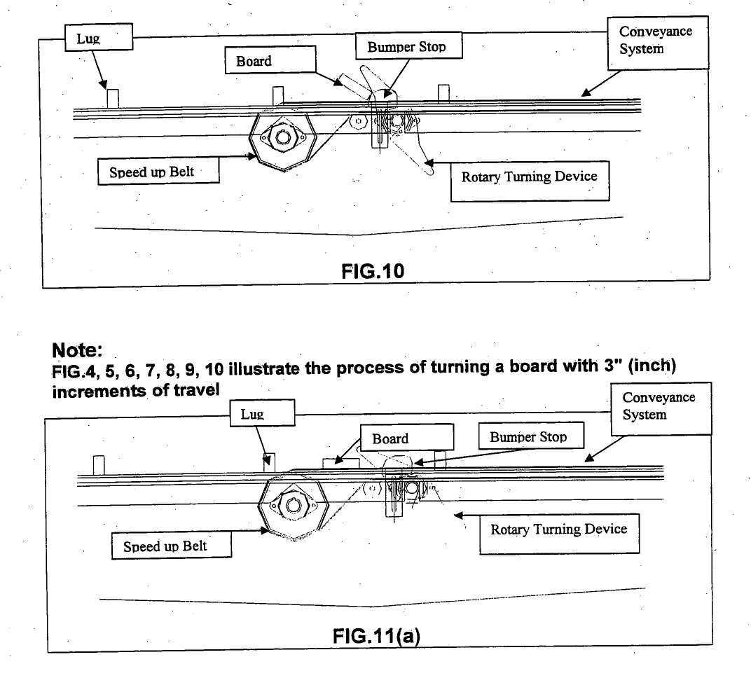

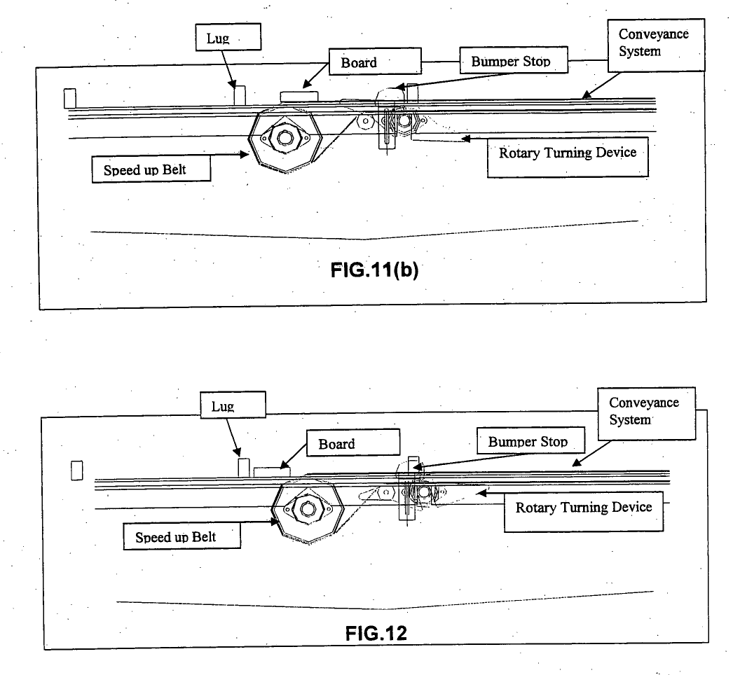

### DETAILED DESCRIPTION OF EMBODIMENTS OF THE INVENTION

Turning now descriptively to the drawings, in which similar reference characters denote similar elements throughout the several views, the attached figures illustrate a powered rotary board turner, which comprises a conveyance system 10 for transporting the board 12, a rotary turning device 14 for rotating in direction a the board 12 at a rate relative to the rate of translation in direction b of the conveyance system10, a bumper stop 16 for restraining the board 12 and a speed up belt 18 for accelerating the board 12 to the front of the conveyance system for example forwardly (also in direction B) in a lug spacing 20a between lugs 20.

The rotary turning device rotates at a rate which is constant relative to the conveyance system. Board 12 is turned while board 12 is being transferred on the conveyor. While in the conveyance system, board 12 is accelerated by the use of speed-up belts 18 or some other forward acceleration means in direction B to the front of the lug space between lugs 20 so as to engage bumper stop 16 at the front of the lug space. Board 12 is stopped by retractable bumper stops 16 which are proud, that is extend upwardly, of the top of conveyance system. Bumper stops 16 may be fixed in a single station system. Board 12 is then picked up by rotary turning device 14 and rotated in direction A over the bumper stops and dropped into the same lug space that it originated from. Thus the board is turned one hundred eighty degrees about its longitudinal axis in the time it takes for the length of the lug space to pass by the bumper stop. In one embodiment the rotary turning device has two arms 14a, 14b and rotates at the rate of ½ a revolution per conveyance system or board. In other embodiments it may for example have only one arm and rotate at 1 revolution per conveyance system or boards, or three arms and rotate at ⅓ a revolution per conveyance system or board. Note that the system is not restricted to a pre-determined number of arms. In the above example if bumper stop 16 was left up, the boards in every conveyance system, for example lug space, would be turned. If you wanted more than one board turner on a given conveyance system, for example more than one board turner per lug space, you could have two or more powered rotary board turners in series. If for example you have two turners and want to turn every second board you could achieve this by having the bumper stops come up in direction C on every second board. The board that the bumper stop did not come up on will pass over the rotary turning device and would not be turned. This could work on any number of board turner stations. If for example you had a four station powered rotary board turner you could run all four stations and lift the bumper stops up for every 4th board at each station. In this case each rotary turning device (2 armed) would rotate in direction A at ½ a revolution per conveyance system (same as a single station) and is capable of turning the boards in all lug spaces if required (leave the bumper stop for that station up). Without having to change the speed of the rotary turning devices relative to the conveyance system rate (or disconnecting the drive mechanism) you could choose to run any number of the four stations in any combination by lifting the bumper stops at the appropriate times.

The rotational actuation means of board turner 14 is advantageously by linkage to the conveyance system so that the device is always in time, that is a constant rotation rate relative to the conveyance system speed.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A rotary board turner comprising a conveyor having discreet board engaging means in spaced relation therealong defining board carrying spaces therebetween for carrying boards aligned across a downstream flow direction,
an acceleration means for accelerating a board in a board carrying space to the downstream most end of the space,
a rigid stop in a board engaging position so as to engage the board in the space when at the downstream-most end of the space,
at least one driven rotator arm for engaging the underside of the board once engaged against the stop so as to rotate the board one hundred eighty degrees over the stop and so as to deposit the board towards the upstream end of the board carrying space.

2. The device of claim 1 wherein said rigid stop is rigidly mounted in said board engaging position.

3. The device of claim 1 wherein said rigid stop is selectively translatable by translation means into said board engaging position.

4. The device of claim 1 wherein said conveyor is a lugged conveyor and said discreet board engaging means are a spaced array of lugs mounted on said conveyor.

5. The device of claim 1 wherein said acceleration means is a speed-up belt.

6. The device of claim 1 wherein said rigid stop is a bumper stop.

7. The device of claim 2 wherein said rigid stop is a bumper stop.

8. The device of claim 3 wherein said rigid stop is a bumper stop.

9. The device of claim 1 wherein said rigid stop is a bumper stop mounted so as to extend into said downstream flow direction to engage the board when in said board carrying space, and wherein said acceleration means has an upstream end and an opposite downstream end, and wherein said bumper stop is adjacent said downstream end of said acceleration means.

10. The device of claim 2 wherein said rigid stop is a bumper stop mounted so as to extend into said downstream flow direction to engage the board when in said board carrying space, and wherein said acceleration means has an upstream end and an opposite downstream end, and wherein said bumper stop is adjacent said downstream end of said acceleration means.

11. The device of claim 3 wherein said rigid stop is a bumper stop mounted so as to extend into said downstream flow direction to engage the board when in said board carrying space, and wherein said acceleration means has an upstream end and an opposite downstream end, and wherein said bumper stop is adjacent said downstream end of said acceleration means.

12. The device of claim 1 wherein said rigid stop is a bumper stop mounted so as to be extendable into said downstream flow direction to engage the board when in said board carrying space, and wherein said acceleration means has an upstream end and an opposite downstream end, and wherein said bumper stop is adjacent said downstream end of said acceleration means.

13. The device of claim 3 wherein said rigid stop is a bumper stop mounted so as to be extendable into said downstream flow direction to engage the board when in said board carrying space, and wherein said acceleration means has an upstream end and an opposite downstream end, and wherein said bumper stop is adjacent said downstream end of said acceleration means.

14. The device of claim 5 wherein said rigid stop is a bumper stop mounted so as to be extendable into said downstream flow direction to engage the board when in said board carrying space, and wherein said acceleration means has an upstream end and an opposite downstream end, and wherein said bumper stop is adjacent said downstream end of said acceleration means.

15. The device of claim 1 wherein said at least one driven rotator arm includes a pair of oppositely disposed rigid arms rigidly cantilevered from a driven shaft.

16. The device of claim 15 wherein said driven shaft is driven at a rotational speed which is constant relative to a translation speed of said conveyor.

17. The device of claim 16 wherein said driven shaft and said conveyor are mechanically linked to one another by driving linkage means so as to provide said constant relative speeds between said shaft and said conveyor.

18. The device of claim 1 wherein said at least one driven rotator arm is mounted cantilevered from a driven shaft and wherein said driven shaft is driven at a rotational speed which is constant relative to a translation speed of said conveyor.

19. The device of claim 18 wherein said driven shaft and said conveyor are mechanically linked to one another by driving linkage means so as to provide said constant relative speeds between said shaft and said conveyor.

20. The device of claim 1 wherein said at least one driven rotator arm is rotatably mounted on driving means mounted beneath an upper surface of said conveyor and adjacent said rigid stop.
